(19) United States
(12) Patent Application Publication
(10) Pub. No.: US 2023/0402221 A1
(43) Pub. Date: Dec. 14, 2023

(54) WOUND CORE, METHOD OF PRODUCING WOUND CORE AND WOUND CORE PRODUCTION DEVICE

(71) Applicant: NIPPON STEEL CORPORATION, Tokyo (JP)

(72) Inventors: Masataka IWAKI, Tokyo (JP); Takahito MIZUMURA, Tokyo (JP); Hisashi MOGI, Tokyo (JP)

(73) Assignee: NIPPON STEEL CORPORATION, Tokyo (JP)

(21) Appl. No.: 18/033,108

(22) PCT Filed: Oct. 26, 2021
(86) PCT No.: PCT/JP2021/039554

§ 371 Date: Apr. 21, 2023

(30) Foreign Application Priority Data
Oct. 26, 2020 (JP) 2020-178560

(51) Int. Cl. H01F 27/245; H01F 1/147; H01F 41/02

(52) U.S. Cl. CPC H01F 27/2455; H01F 1/14775; H01F 41/024

(57) ABSTRACT

A wound core (10) is a wound core including a portion in which grain-oriented electrical steel sheets (1) in which planar portions (4) and bent portions (5) are alternately continuous in a longitudinal direction are stacked in a sheet thickness direction and formed by stacking the grain-oriented electrical steel sheets (1) that have been individually bent in layers and assembled into a wound shape, wherein, when an average length of a roughness curve element in a width direction intersecting the longitudinal direction forming a surface of the bent portion (5) of the grain-oriented electrical steel sheet (1) is RSm(b), and an average length of the roughness curve element in the width direction forming a surface of the planar portion 4 of the grain-oriented electrical steel sheet (1) is RSm(s), the relationship of 1.00<RSm(b)/RSm(s)≤5.00 is satisfied.

### TECHNICAL FIELD

The present invention relates to a wound core, a method of producing a wound core, and a wound core production device. Priority is claimed on Japanese Patent Application No. 2020-178560, filed Oct. 26, 2020, the content of which is incorporated herein by reference.

### BACKGROUND ART

Transformer iron cores include stacked iron cores and wound cores. Among these, the wound core is generally produced by stacking grain-oriented electrical steel sheets in layers, winding them in a donut shape (wound shape), and then pressing the wound body to mold it into substantially a rectangular shape (in this specification, a wound core produced in this manner may be referred to as a trunk core). According to this molding process, mechanical processing strain (plastic deformation strain) is applied to all of the grain-oriented electrical steel sheets, and the processing strain is a factor that greatly deteriorates the iron loss of the grain-oriented electrical steel sheet so that it is necessary to perform strain relief annealing.

On the other hand, as another method of producing a wound core, techniques such as those found in Patent Documents 1 to 3 in which portions of steel sheets that become corner portions of a wound core are bent in advance so that a relatively small bending area with a radius of curvature of 3 mm or less is formed and the bent steel sheets are laminated to form a wound core are disclosed (in this specification, the wound core produced in this manner may be referred to as Unicore (registered trademark)). According to this production method, a conventional large-scale pressing process is not required, the steel sheet is precisely bent to maintain the shape of the iron core, and processing strain is concentrated only in the bent portion (corner) so that it is possible to omit strain removal according to the above annealing process, and its industrial advantages are great and its application is progressing.

### CITATION LIST

### Patent Document

### [Patent Document 1]

Japanese Unexamined Patent Application, First Publication No. 2005-286169

### [Patent Document 2]

Japanese Patent No. 6224468

### [Patent Document 3]

Japanese Unexamined Patent Application, First Publication No. 2018-148036

### SUMMARY OF THE INVENTION

### Problems to be Solved by the Invention

Incidentally, in the production of Unicore, it is necessary to adjust the bent angle at portions that become corners when the grain-oriented electrical steel sheet is bent. However, in the conventional bending, it was not easy to adjust the bent angle due to an influence of tension of a coating formed on the surface of the grain-oriented electrical steel sheet in order to reduce iron loss. That is, the angle could not be controlled due to bending return, elastic stress occurred in the iron core after the steel sheets were stacked, and the iron loss was inferior. For example, in Patent Document 3, elastic stress occurred because the average length of the roughness curve elements of the grain-oriented electrical steel sheets was not controlled. Therefore, in the method described in Patent Document 3, the occurrence of elastic stress could not be minimized.

The present invention has been made in view of the above circumstances, and an object of the present invention is to provide a wound core, a method of producing a wound core, and a wound core production device through which bending return after bending can be minimized and deterioration of iron loss can be minimized.

### Means for Solving the Problem

In order to achieve the above object, the present invention provides a wound core including a portion in which grain-oriented electrical steel sheets in which planar portions and bent portions are alternately continuous in a longitudinal direction are stacked in a sheet thickness direction and formed by stacking the grain-oriented electrical steel sheets that have been individually bent in layers and assembled into a wound shape, wherein, when an average length of a roughness curve element in a width direction intersecting the longitudinal direction forming a surface of the bent portion of the grain-oriented electrical steel sheet is RSm (b), and an average length of the roughness curve element in the width direction forming a surface of the planar portion of the grain-oriented electrical steel sheet is RSm (s), the relationship of 1.00<RSm (b)/RSm (s)≤5.00 is satisfied.

The wound core having the above configuration of the present invention is formed by stacking the grain-oriented electrical steel sheets that have been individually bent in layers and assembled into a wound shape (a so-called Unicore in which strain relief annealing can be omitted), and when bending is performed while compressive stress is applied to the entire end surface (L cross section) of the steel sheet to be bent in the width direction, the average length of the roughness curve element in the width direction intersecting the longitudinal direction forming the surface (outline) of the bent portion of the grain-oriented electrical steel sheet is RSm (b), and the average length of the roughness curve element in the width direction forming the surface (outline) of the planar portion of the grain-oriented electrical steel sheet is RSm (s), the relationship of 1.00<RSm (b)/RSm (s)≤5.00 is satisfied. Here, the surface of the bent portion and the surface of the planar portion refer to the surface (the outer surface of the bent portion and the planar portion) facing the outside of the wound core. Average lengths RSm (a) and Rsm (b) of the roughness curve element are the average length RSm of the roughness curve element defined in Japanese Industrial Standard JIS B 0601 (2013).

As described above, in the production of Unicore, it is necessary to adjust the bent angle at portions that become corners when the grain-oriented electrical steel sheet is bent, and conventionally, it was not easy to adjust the bent angle in bending due to an influence of tension of a coating on the steel sheet. Therefore, there were problems that the angle could not be controlled due to bending return, elastic stress occurred in the iron core after the steel sheets were stacked, and the iron loss was inferior. Therefore, the inventors focused on the fact that bending return after bending of the steel sheet is reduced when the grain-oriented electrical steel sheet is bent while compressive stress is applied in the width direction, and found that, when bending is performed while compressive stress is applied to the entire end surface (L cross section) of the steel sheet to be bent in the width direction, and the relationship of 1.00<RSm (b)/RSm (s)≤5.00 is satisfied (alternatively, the average length RSm of the roughness curve element inside and outside the bent portion of the grain-oriented electrical steel sheet is controlled), the iron loss of the entire iron core is improved. This is thought to be due to the fact that, due to minimization of bending return, the elastic stress acting in the iron core is reduced when the steel sheets are stacked and assembled, and deterioration of the iron loss is reduced. In addition, elastic stress is reduced and thus noise properties are also improved.

Here, the average length RSm of the roughness curve element is determined according to Japanese Industrial Standard JIS B 0601 (2013). In addition, in the above configuration, the bent portion of the grain-oriented electrical steel sheet preferably has a radius of curvature of 1 mm or more and 5 mm or less. Here, the radius of curvature of the bent portion is the inner radius of curvature of the bent portion in a side view.

In addition, the present invention provides a method of producing a wound core including a bending process in which grain-oriented electrical steel sheets are individually bent; and an assembling process in which the bent grain-oriented electrical steel sheets are stacked in layers and assembled into a wound shape to form a wound core having a wound shape including a portion in which grain-oriented electrical steel sheets in which planar portions and bent portions are alternately continuous in a longitudinal direction are stacked in a sheet thickness direction, wherein, in the bending process, the grain-oriented electrical steel sheet is bent while a compressive stress in a range of 3 MPa or more and 17 MPa or less is applied to the grain-oriented electrical steel sheet in a width direction.

In addition, the present invention provides a wound core production device including a bending unit that individually bends grain-oriented electrical steel sheets; and an assembly unit that stacks the bent grain-oriented electrical steel sheets in layers and assembles them into a wound shape to form a wound core having a wound shape including a portion in which grain-oriented electrical steel sheets in which planar portions and bent portions are alternately continuous in a longitudinal direction are stacked in a sheet thickness direction, wherein the bending unit bends the grain-oriented electrical steel sheet while applying a compressive stress in a range of 3 MPa or more and 17 MPa or less to the grain-oriented electrical steel sheet in a width direction.

In the production method and production device having the above configuration, when the grain-oriented electrical steel sheets are individually bent, the grain-oriented electrical steel sheet is bent while a compressive stress in a range of 3 MPa or more and 17 MPa or less is applied to the grain-oriented electrical steel sheet in the width direction (the direction intersecting the rolling direction which is the longitudinal direction of the steel sheet). When the steel sheet is bent while compressive stress is applied under such conditions, as a result, the relationship of 1.00<RSm(b)/RSm(s)≤5.00 is satisfied, and the same operational effects as in the above wound core can be obtained. That is, due to the influence of compressive stress applied in the width direction, the bending return after bending of the steel sheet is reduced, as a result, the elastic stress acting in the iron core is reduced when the steel sheets are stacked and assembled, and deterioration of the iron loss of the entire iron core is reduced. In addition, the elastic stress is reduced and thus noise properties are also improved. In addition, in the production method and production device having the above configuration, in the bending, it is preferable to bend the grain-oriented electrical steel sheet at a strain rate of 5 mm/sec or more and 100 mm/sec or less while a compressive stress in a range of 3 MPa or more and 17 MPa or less is applied to the grain-oriented electrical steel sheet in the width direction. In addition, in the bending, the grain-oriented electrical steel sheet is preferably bent so that the radius of curvature of the bent portion of the grain-oriented electrical steel sheet is 1 mm or more and 5 mm or less.

### Effects of the Invention

According to the present invention, when bending is performed while compressive stress is applied to the grain-oriented electrical steel sheet in the width direction, the relationship of 1.00<RSm(b)/RSm(s)≤5.00 is satisfied so that bending return after bending can be minimized and deterioration of the iron loss can be reduced.

### BRIEF DESCRIPTION OF DRAWINGS

FIG. 1 is a perspective view schematically showing a wound core according to one embodiment of the present invention.

FIG. 2 is a side view of the wound core shown in the embodiment of FIG. 1.

FIG. 3 is a side view schematically showing a wound core according to another embodiment of the present invention.

FIG. 4 is a side view schematically showing an example of a single-layer grain-oriented electrical steel sheet constituting a wound core.

FIG. 5 is a side view schematically showing another example of the single-layer grain-oriented electrical steel sheet constituting the wound core.

FIG. 6 is a side view schematically showing an example of a bent portion of the grain-oriented electrical steel sheet constituting the wound core of the present invention.

FIG. 7 is a diagram showing an example of a method of measuring an average length RSm(b) of a roughness curve element in the width direction forming the surface of a bent portion and an average length RSm(s) of a roughness curve element in the width direction forming the surface of a planar portion.

FIG. 8 is a schematic perspective view showing an example of a device for realizing bending in which a steel sheet is bent while applying compressive stress to the entire end surface of the steel sheet to be bent in the width direction.

FIG. 9 is a block diagram schematically showing a configuration of a device for producing a Unicore type wound core containing grain-oriented electrical steel sheets with elastic deformation in the planar portion.

FIG. 10 is a schematic view showing sizes of a wound core produced when properties are evaluated.

### EMBODIMENT(S) FOR IMPLEMENTING THE INVENTION

Hereinafter, a wound core according to one embodiment of the present invention will be described in detail in order. However, the present invention is not limited to only the configuration disclosed in the present embodiment, and can be variously modified without departing from the gist of the present invention. Here, lower limit values and upper limit values are included in the numerical value limiting ranges described below. Numerical values indicated by “more than” or “less than” are not included in these numerical value ranges. In addition, unless otherwise specified. “%” relating to the chemical composition means “mass %.”

In addition, terms such as “parallel,” “perpendicular,” “identical,” and “right angle” and length and angle values used in this specification to specify shapes, geometric conditions and their extents are not bound by strict meanings, and should be interpreted to include the extent to which similar functions can be expected.

In addition, in this specification, “grain-oriented electrical steel sheet” may be simply described as “steel sheet” or “electrical steel sheet,” and “wound core” may be simply described as “iron core.”

The wound core according to one embodiment of the present invention is a wound core including a substantially rectangular wound core main body in a side view, and the wound core main body includes a portion in which grain-oriented electrical steel sheets in which planar portions and bent portions are alternately continuous in the longitudinal direction are stacked in a sheet thickness direction and has a substantially polygonal laminated structure in a side view. The inner radius of curvature r of the bent portion in a side view is, for example, 1 mm or more and 5 mm or less. As an example, the grain-oriented electrical steel sheet has a chemical composition containing, in mass %, Si: 2.0 to 7.0%, with the remainder being Fe and impurities, and has a texture oriented in the Goss orientation. As the grain-oriented electrical steel sheet, for example, a grain-oriented electromagnetic steel band described in JIS C 2553: 2019 can be used.

Next, the shapes of the wound core and the grain-oriented electrical steel sheet according to one embodiment of the present invention will be described in detail. The shapes themselves of the wound core and the grain-oriented electrical steel sheet described here are not particularly new, and merely correspond to the shapes of known wound cores and grain-oriented electrical steel sheets.

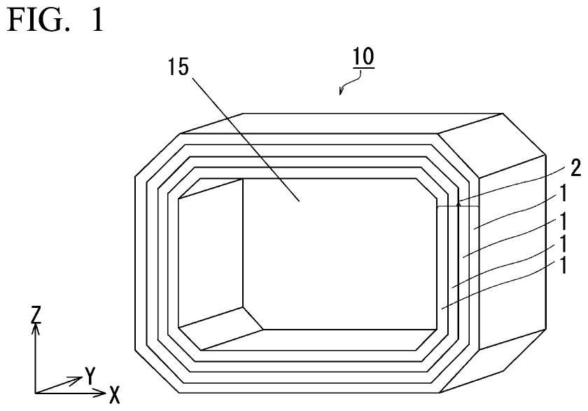

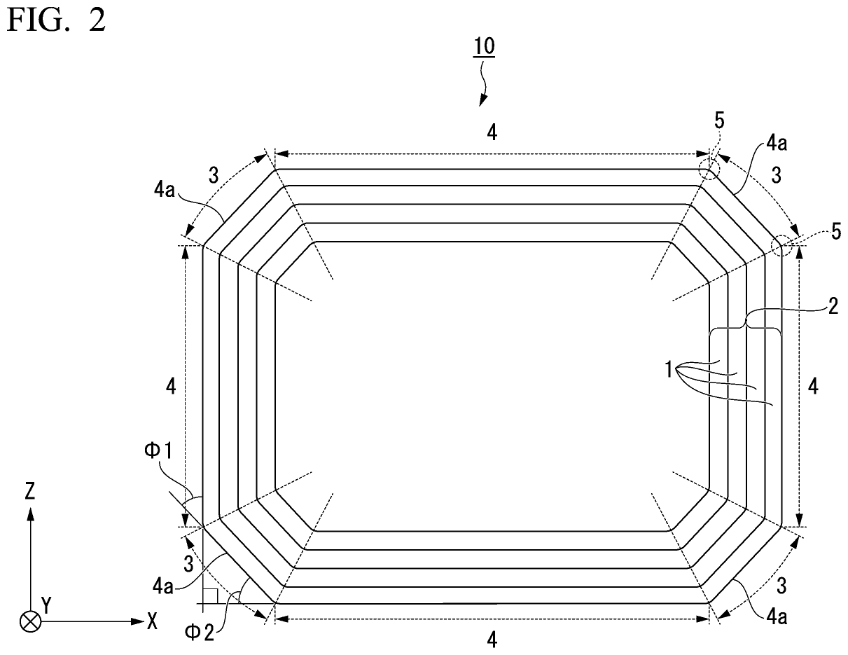

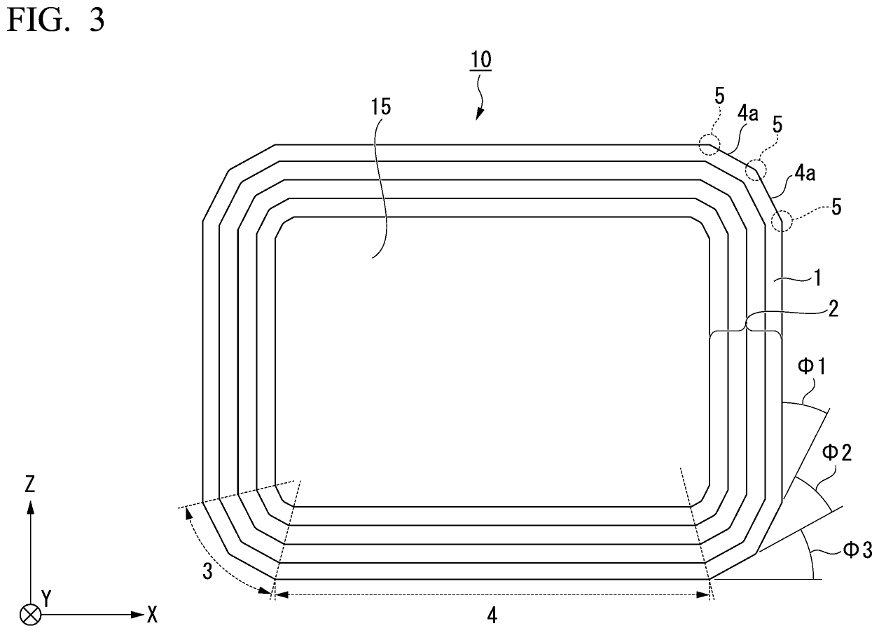

FIG. 1 is a perspective view schematically showing a wound core according to one embodiment. FIG. 2 is a side view of the wound core shown in the embodiment of FIG. 1. In addition, FIG. 3 is a side view schematically showing another embodiment of the wound core.

Here, in the present invention, the side view is a view of the long-shaped grain-oriented electrical steel sheet constituting the wound core in the width direction (Y-axis direction in FIG. 1). The side view is a view showing a shape visible from the side (a view in the Y-axis direction in FIG. 1).

A wound core 10 according to one embodiment of the present invention includes a substantially polygonal wound core main body in a side view. The wound core main body 10 has a substantially rectangular laminated structure in a side view in which grain-oriented electrical steel sheets 1 are stacked in a sheet thickness direction. The wound core main body 10 may be used as a wound core without change, or may include, as necessary, for example, a known fastener such as a binding band for integrally fixing a plurality of stacked grain-oriented electrical steel sheets.

In the present embodiment, the iron core length of the wound core main body 10 is not particularly limited. If the number of bent portions 5 is the same, even if the iron core length of the wound core main body 10 changes, the volume of the bent portion 5 is constant so that the iron loss generated in the bent portion 5 is constant. If the iron core length is longer, the volume ratio of the bent portion 5 to the wound core main body 10 is smaller and the influence on iron loss deterioration is also small. Therefore, a longer iron core length of the wound core main body 10 is preferable. The iron core length of the wound core main body 10 is preferably 1.5 m or more and more preferably 1.7 m or more. Here, in the present invention, the iron core length of the wound core main body 10 is the circumferential length at the central point in the laminating direction of the wound core main body 10 in a side view.

Such a wound core can be suitably used for any conventionally known application.

The iron core according to the present embodiment has substantially a polygonal shape in a side view. In the description using the following drawings, for simplicity of illustration and description, a substantially rectangular (square) iron core, which is a general shape, will be described, but iron cores having various shapes can be produced depending on the angle and number of bent portions 5 and the length of a planar portion 4. For example, if the angles of all the bent portions 5 are 45° and the lengths of the planar portions 4 are equal, the side view is octagonal. In addition, if the angle is 60°, there are six bent portions 5, and the lengths of the planar portions 4 are equal, the side view is hexagonal.

As shown in FIG. 1 and FIG. 2, the wound core main body 10 includes a portion in which the grain-oriented electrical steel sheets 1 in which the planar portions 4 and the bent portions 5 are alternately continuous in the longitudinal direction are stacked in a sheet thickness direction and has a substantially rectangular laminated structure 2 having a hollow portion 15 in a side view. A corner portion 3 including the bent portion 5 has two or more bent portions 5 having a curved shape in a side view, and the sum of the bent angles of the bent portions 5 present in one corner portion 3 is, for example, 90°. The corner portion 3 has a planar portion 4a shorter than the planar portion 4 between the adjacent bent portions 5 and 5. Therefore, the corner portion 3 has a form including two or more bent portions 5 and one or more planar portions 4a. Here, in the embodiment of FIG. 2, one bent portion 5 has an angle of 45°. In the embodiment of FIG. 3, one bent portion 5 has an angle of 30°.

As shown in these examples, the wound core of the present embodiment can be formed with bent portions having various angles, but in order to minimize the occurrence of distortion due to deformation during processing and minimize the iron loss, the bent angle φ (φ1, φ2, φ3) of the bent portion 5 is preferably 60° or less and more preferably 45° or less. The bent angle φ of the bent portion of one iron core can be arbitrarily formed. For example, φ1=60° and φ2=30° can be set but it is preferable that folding angles (bent angles) be equal in consideration of production efficiency.

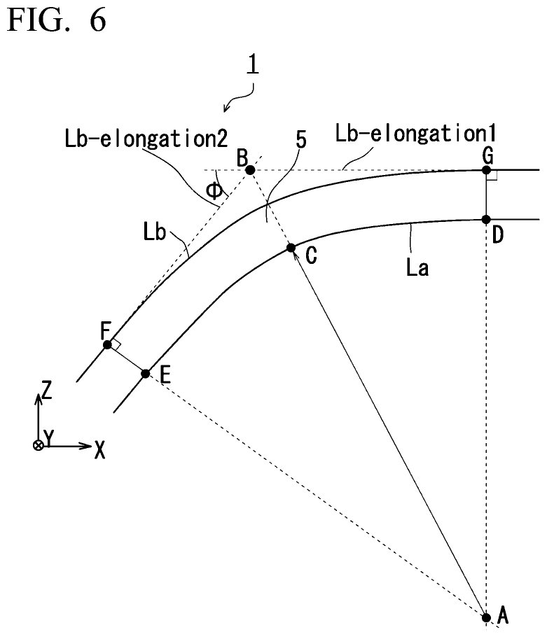

The bent portion 5 will be described in more detail with reference to FIG. 6. FIG. 6 is a diagram schematically showing an example of the bent portion (curved portion) 5 of the grain-oriented electrical steel sheet 1. The bent angle of the bent portion 5 is the angle difference occurring between the rear straight portion and the front straight portion in the bending direction at the bent portion 5 of the grain-oriented electrical steel sheet 1, and is expressed, on the outer surface of the grain-oriented electrical steel sheet 1, as an angle φ that is a supplementary angle of the angle formed by two virtual lines Lb-elongation1 and Lb-elongation2 obtained by extending the straight portions that are surfaces of the planar portions 4 and 4a on both sides across the bent portion 5. In this case, the point at which the extended straight line separates from the surface of the steel sheet is the boundary between the planar portion 4 and the bent portion 5 on the outer surface of the steel sheet, which is the point F and the point G in FIG. 6.

In addition, straight lines perpendicular to the outer surface of the steel sheet extend from the point F and the point G and intersections with the inner surface of the steel sheet are the point E and the point D. The point E and the point D are the boundaries between the planar portion 4 and the bent portion 5 on the inner surface of the steel sheet.

Here, in the present invention, the bent portion 5 is a portion of the grain-oriented electrical steel sheet 1 surrounded by the point D, the point E, the point F, and the point G in a side view of the grain-oriented electrical steel sheet 1. In FIG. 6, the surface of the steel sheet between the point D and the point E, that is, the inner surface of the bent portion 5, is indicated by La, and the surface of the steel sheet between the point F and the point G, that is, the outer surface of the bent portion 5, is indicated by Lb.

In addition, this drawing shows the inner radius of curvature r of the bent portion 5 in a side view. The radius of curvature r of the bent portion 5 is obtained by approximating the above La with a circular arc passing through the point E and the point D. A smaller radius of curvature r indicates a sharper curvature of the curved portion of the bent portion 5, and a larger radius of curvature r indicates a gentler curvature of the curved portion of the bent portion 5.

In the wound core 10 of the present invention, the radius of curvature r at each bent portion 5 of the grain-oriented electrical steel sheets 1 laminated in the sheet thickness direction may vary to some extent. This variation may be a variation due to molding accuracy, and it is conceivable that an unintended variation may occur due to handling during lamination. Such an unintended error can be minimized to about 0.3 mm or less in current general industrial production. If such a variation is large, a representative value can be obtained by measuring the curvature radii of a sufficiently large number of steel sheets and averaging them. In addition, it is conceivable to change it intentionally for some reason, and the present invention does not exclude such a form.

Here, the method of measuring the radius of curvature r of the bent portion 5 is not particularly limited, and for example, the radius of curvature r can be measured by performing observation using a commercially available microscope (Nikon ECLIPSE LV150) at a magnification of 200. Specifically, the curvature center point A is obtained from the observation result, and for a method of obtaining this, for example, if the intersection of the line segment EF and the line segment DG extended inward on the side opposite to the point B is defined as A, the magnitude of the radius of curvature r corresponds to the length of the line segment AC. Here, when the point A and the point B are connected by a straight line, the intersection on a circular arc DE inside the bent portion of the steel sheet is C.

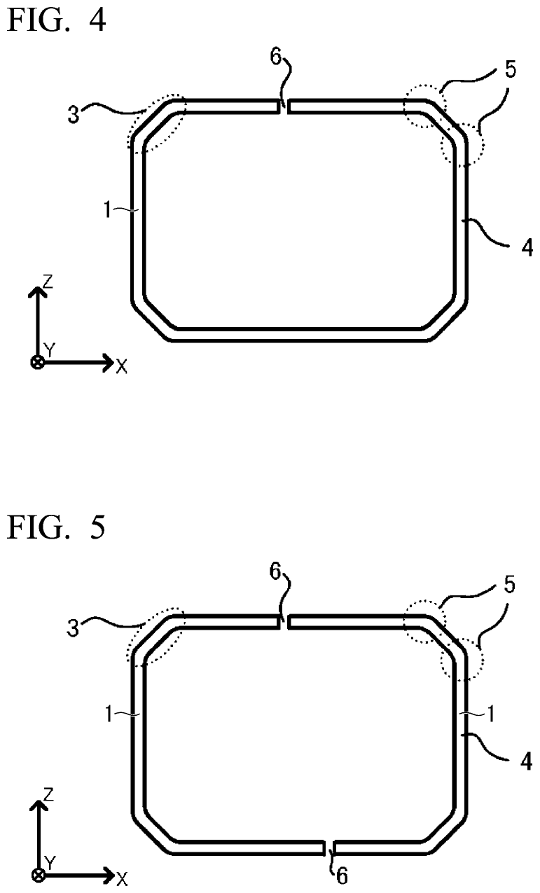

FIG. 4 and FIG. 5 are diagrams schematically showing an example of a single-layer grain-oriented electrical steel sheet 1 in a wound core main body. The grain-oriented electrical steel sheet 1 used in the examples of FIG. 4 and FIG. 5 is bent to realize a Unicore type wound core, and includes two or more bent portions 5 and the planar portion 4, and forms a substantially polygonal ring in a side view via a joining part 6 (gap) that is an end surface of one or more grain-oriented electrical steel sheets 1 in the longitudinal direction.

In the present embodiment, the entire wound core main body 10 may have a substantially polygonal laminated structure in a side view. As shown in the example of FIG. 4, one grain-oriented electrical steel sheet may form one layer of the wound core main body 10 via one joining part 6 (one grain-oriented electrical steel sheet is connected via one joining part 6 for each roll), and as shown in the example of FIG. 5, one grain-oriented electrical steel sheet 1 may form about half the circumference of the wound core, and two grain-oriented electrical steel sheets 1 may form one layer of the wound core main body via two joining parts 6 (two grain-oriented electrical steel sheets 1 are connected to each other via two joining parts 6 for each roll).

The sheet thickness of the grain-oriented electrical steel sheet 1 used in the present embodiment is not particularly limited, and may be appropriately selected according to applications and the like, but is generally within a range of 0.15 mm to 0.35 mm and preferably in a range of 0.18 mm to 0.23 mm.

In addition, the method of producing the grain-oriented electrical steel sheet 1 is not particularly limited, and a conventionally known method of producing a grain-oriented electrical steel sheet can be appropriately selected. Specific examples of a preferable production method include, for example, a method in which a slab containing 0.04 to 0.1 mass % of C, with the remainder being the chemical composition of the grain-oriented electrical steel sheet, is heated to 1,000° C. or higher and hot-rolled sheet annealing is then performed as necessary, and a cold-rolled steel sheet is then obtained by cold-rolling once, twice or more with intermediate annealing, the cold-rolled steel sheet is heated, decarburized and annealed, for example, at 700 to 900° C. in a wet hydrogen-inert gas atmosphere, and as necessary, nitridation annealing is additionally performed, an annealing separator is applied, finish annealing is then performed at about 1,000° C., and an insulation coating is formed at about 900° C. In addition, after that, a coating or the like for adjusting the dynamic friction coefficient may be implemented.

In addition, generally, the effects of the present invention can be obtained even with a steel sheet that has been subjected to a treatment called “magnetic domain control” using strain, grooves or the like in the steel sheet producing process by a known method.

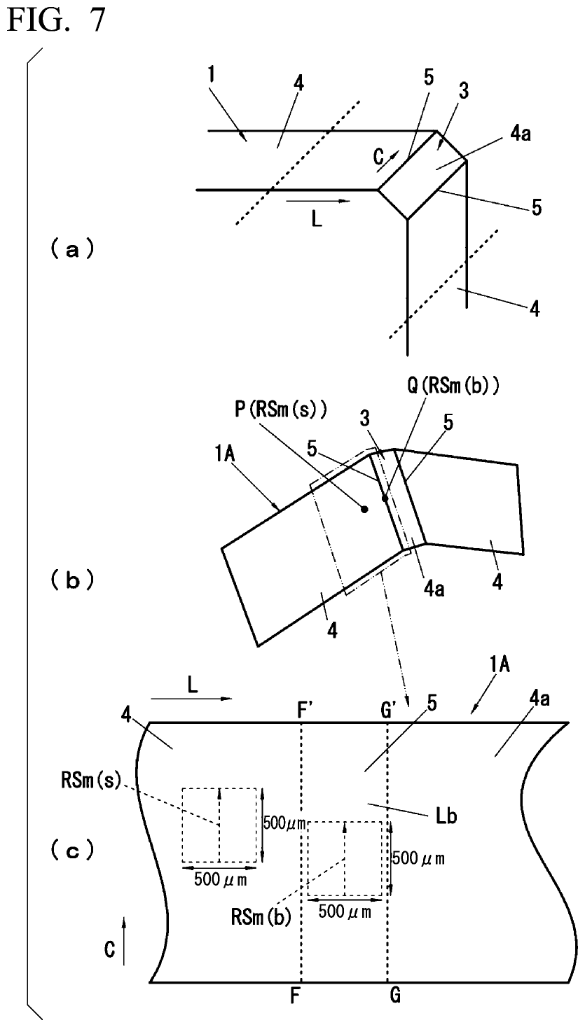

In addition, in the present embodiment, the wound core 10 composed of the grain-oriented electrical steel sheet 1 having the above form is formed by stacking the grain-oriented electrical steel sheets 1 that have been individually bent in layers and assembled into a wound shape, and a plurality of grain-oriented electrical steel sheets 1 are connected to each other via at least one joining part 6 for each roll. In addition, during individual bending, bending is performed while compressive stress is applied to the entire end surface (L cross section) of the steel sheet to be bent in the width direction. Thus, when the average length of the roughness curve element in the width direction (Y-axis direction in FIG. 1) intersecting the longitudinal direction (the rolling direction L in FIG. 7) forming the surface (outline) of the bent portion 5 of the grain-oriented electrical steel sheet is RSm(b), and the average length of the roughness curve element in the width direction forming the surface (outline) of the planar portion 4 (4a) of the grain-oriented electrical steel sheet 1 is RSm(s), the relationship of 1.00<RSm(b)/RSm(s)≤5.00 is satisfied. In addition, in this case, the above radius of curvature (the inner radius of curvature of the bent portion 5 in a side view) r of the bent portion 5 is preferably 1 mm or more and 5 mm or less. When the radius of curvature r is set to 1 mm or more and 5 mm or less, it is possible to further minimize the building factor (BF).

Here, regarding the average length RSm(b) of the roughness curve element in the width direction forming the surface of the bent portion 5 and the average length RSm(s) of the roughness curve element in the width direction forming the surface of the planar portion 4 (4a), and average values are obtained by performing measurement at 10 fields of view at the bent portion 5 and the planar portion 4 (4a), for example, using a digital microscope (VHX-7000, commercially available from Keyence Corporation). Specifically, for example, a part of the grain-oriented electrical steel sheet 1 constituting the wound core is sheared and cut out as indicated by a dashed line in FIG. 7(a), and a cut steel sheet 1A including one corner portion 3 and planar portions 4 on both sides thereof as shown in FIG. 7(b) is obtained. During cutting, it is desirable to cut the planar portion 4 (4a) so that the bent portion 5 is not crushed. Here, regarding the cut steel sheet 1A, using the digital microscope, the outer surface of the planar portion 4 (4a) and the outer surface (Lb) of the bent portion 5 of the grain-oriented electrical steel sheet 1 facing the outside of the wound core are measured. Regarding the measurement position, it is desirable to perform measurement at the center of the steel sheet width (refer to measurement positions P and Q in FIG. 7(b)) far from the end surface of the steel sheet 1A. Here, as shown in FIG. 7(c), the bent portion 5, that is, a portion of the grain-oriented electrical steel sheet 1 surrounded by the point D, the point E, the point F, and the point G in FIG. 6, that is, in FIG. 7(c) showing a plane extending in a width direction C and a longitudinal direction L, an outer surface (Lb) portion surrounded by the point F, the point F,′ the point G, and the point G′ is scanned from above using the digital microscope in the width direction C as indicated by a dashed arrow, and RSm(b) is measured. Here, if necessary, the bent portion 5 to be measured may be marked in advance with a marker or the like. Similarly, regarding the planar portion 4 (4a), the outer surface portion is scanned from above using the digital microscope in the width direction C as indicated by a dashed arrow and RSm(s) is measured. The planar portion 4 (4a) may be separately collected from the planar portion 4 (4a) of the same iron core or may be collected from a hoop left over after the iron core is produced. In any case, a steel sheet that is not plastically deformed may be used. For example, regarding the field of view for measurement, for example, the magnification is set to 200 so that the width of one field of view shown in FIG. 7(c) is 500 μm×500 μm. The average length RSm of the roughness curve element is measured according to JIS B 0601 (2013). In addition, when the average length RSm of the roughness curve element is measured under a digital microscope, the cutoff value λs=0 μm and the cutoff value λc=0 mm, and vibration correction may be performed for measurement. The measurement magnification is preferably 100 or more and more preferably 500 to 700. Then, such measurement is performed on, for example, 10 cut steel sheets 1A, and average values thereof are defined as RSm(b) and RSm(s). Here, Rsm(b) is preferably 0.5 μm to 3.5 μm. Rsm(b) is more preferably 0.8 to 3.1 μm. In addition, Rsm(s) is preferably 0.5 μm to 1.0 μm. Ra(s) is more preferably 0.5 μm to 0.7 μm.

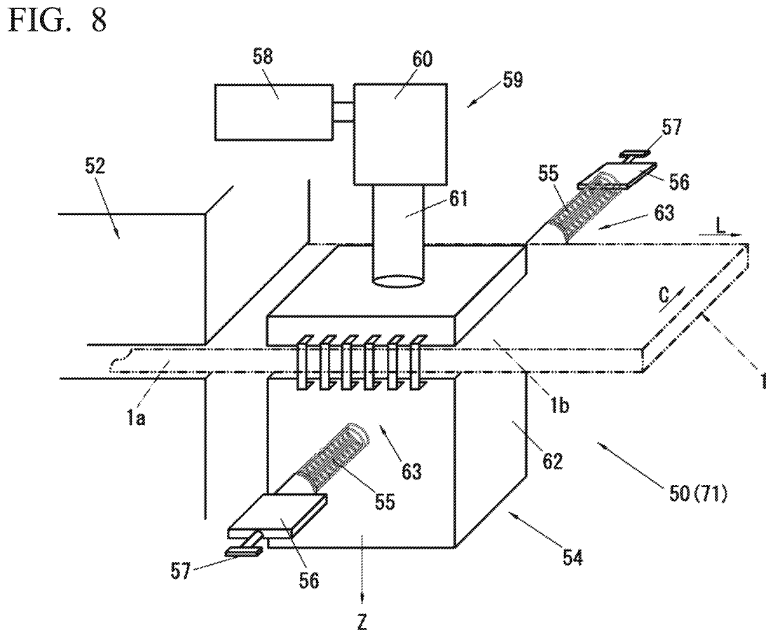

In addition, bending performed to satisfy the relationship of 1.00<RSm(b)/RSm(s)≤5.00, that is, bending performed while applying compressive stress to the entire end surface (L cross section) of the steel sheet to be bent in the width direction C, is performed by, for example, a bending unit 71 including a device 50 as shown in FIG. 8. The device 50 shown in FIG. 8 includes a steel sheet holding unit 52 that holds and fixes one side portion 1a of the grain-oriented electrical steel sheet 1, for example, in a holding state, and a bending mechanism 54 for performing bending in a direction Z perpendicular to the longitudinal direction L and the width direction C while holding other side end 1b of the grain-oriented electrical steel sheet 1 to be bent and applying compressive stress from both sides in the width direction C. Specifically, the bending mechanism 54 includes a holding portion 62 that holds the other side end 1b of the grain-oriented electrical steel sheet 1, for example, in the direction Z perpendicular to the longitudinal direction L and the width direction C in a clamping manner, a compressive stress applying unit 63 that is provided on both sides of the holding portion 62 in the width direction C and applies a compressive stress in a range of 3 MPa or more and 17 MPa or less to the other side end 1b of the grain-oriented electrical steel sheet 1 held by the holding portion 62 via the holding portion 62 in the width direction C, and a bent portion forming portion 59 that presses down the holding portion 62 in the Z direction, bends the other side end 1b of the grain-oriented electrical steel sheet 1 held by the holding portion 62, for example, at a strain rate of 5 mm/sec or more and 100 mm/sec or less, and forms the bent portion 5. The compressive stress applying unit 63 can control compressive stress by a load meter 56 using a spring 55 and can set a load by a handle 57. In addition, the bent portion forming portion 59 includes a servo motor 58, a pump 60 that is driven by the servo motor 58, and an elevating portion 61 that is connected to the upper end of the holding portion 62, and the holding portion 62 can be moved in the Z direction by raising and lowering the elevating portion 61 with the pressure generated by the pump 60.

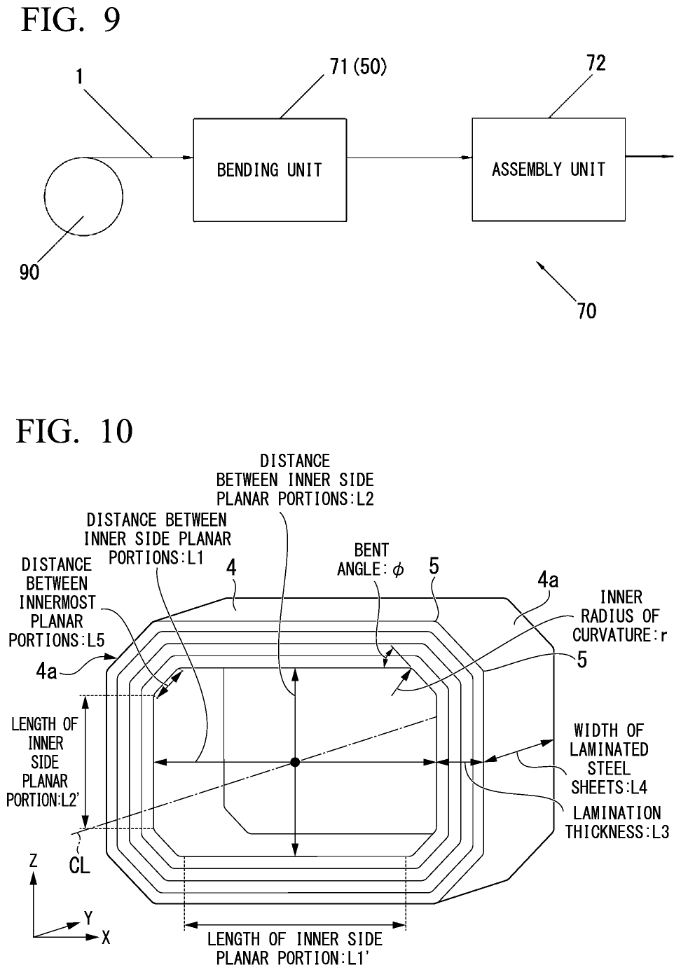

FIG. 9 schematically shows a production device 70 for a Unicore type wound core, and the production device 70 includes the bending unit 71 including the above device 50 for individual bending the grain-oriented electrical steel sheet 1, and stacks the bent grain-oriented electrical steel sheets 1 in layers and assembles them into a wound shape to form a wound core having a wound shape including a portion in which the grain-oriented electrical steel sheets 1 in which the planar portions 4 and the bent portions 5 are alternately continuous in the longitudinal direction are stacked in a sheet thickness direction. In this case, it may further include an assembly unit 72 that stacks the bent grain-oriented electrical steel sheets 1 in layers and assembles them into a wound shape.

The grain-oriented electrical steel sheets 1 are a fed at a predetermined conveying speed from a steel sheet supply unit 90 that holds a hoop member formed by winding the grain-oriented electrical steel sheet 1 in a roll shape and supplied to the bending unit 71. The grain-oriented electrical steel sheets 1 supplied in this manner are appropriately cut to an appropriate size in the bending unit 71 and subjected to bending in which a small number of sheets are individually bent such as one sheet at a time (bending process). In this bending, as described above, while a compressive stress in a range of 3 MPa or more and 17 MPa or less is applied to the grain-oriented electrical steel sheet 1 in the width direction C, the grain-oriented electrical steel sheet 1 is bent, for example, at a strain rate of 5 mm/sec or more and 100 mm/sec or less to form the bent portion 5. In the conventional Unicore production method, the grain-oriented electrical steel sheet 1 was not bent while applying compressive stress. Therefore, the Unicore produced by the conventional production method did not satisfy 1.00<RSm(b)/RSm(s)≤5.00. In the production method of the present disclosure, a compressive stress in a range of 3 MPa or more and 17 MPa or less is applied to the grain-oriented electrical steel sheet 1, and thus 1.00<RSm(b)/RSm(s)≤5.00 can be satisfied. In the bending process, it is preferable to bend the grain-oriented electrical steel sheet 1 so that the radius of curvature of the bent portion is 1 mm or more and 5 mm or less. In the grain-oriented electrical steel sheet 1 obtained in this manner, since the radius of curvature of the bent portion 5 caused by bending is very small, the processing strain applied to the grain-oriented electrical steel sheet 1 by bending is very small. In this manner, while the density of the processing strain is expected to increase, if the volume influenced by the processing strain can be reduced, the annealing process can be omitted. In addition, the grain-oriented electrical steel sheets 1 cut and bent in this manner are stacked in layers and assembled into a wound shape, for example, by the assembly unit 72, to form a wound core (assembling process).

Next, data verifying that the iron loss is minimized with the wound core 10 having the above configuration according to the present embodiment is shown below.

The inventors produced iron cores a to f having shapes shown in Table 1 and FIG. 10 using respective steel sheets as materials when acquiring the verification data.

Here, L1 is parallel to the X-axis direction and is a distance between parallel grain-oriented electrical steel sheets 1 on the innermost periphery of the wound core in a flat cross section including the center CL (a distance between inner side planar portions). L2 is parallel to the Z-axis direction and is a distance between parallel grain-oriented electrical steel sheets 1 on the innermost periphery of the wound core in a vertical cross section including the center CL (a distance between inner side planar portions). L3 is parallel to the X-axis direction and is a lamination thickness of the wound core in a flat cross section including the center CL (a thickness in the laminating direction). L4 is parallel to the X-axis direction and is a width of the laminated steel sheets of the wound core in a flat cross section including the center CL. L5 is a distance between planar portions that are adjacent to each other in the innermost portion of the wound core and arranged to form a right angle together (a distance between bent portions). In other words, L5 is a length of the planar portion 4a in the longitudinal direction having the shortest length among the planar portions 4 and 4a of the grain-oriented electrical steel sheets on the innermost periphery. r is the radius of curvature of the bent portion 5 on the inner side of the wound core, and φ is the bent angle of the bent portion 5 of the wound core. The substantially rectangular iron cores a to f in Table 1 have a structure in which a planar portion with an inner side planar portion distance of L1 is divided at approximately in the center of the distance L1 and two iron cores having “substantially a U-shape” are connected.

Here, the iron core of the core No. e is conventionally used as a general wound core, and is a so-called trunk core type wound core produced by a method of shearing a steel sheet, winding it into a cylindrical shape, then pressing the cylindrical laminated body without change, and forming it into substantially a rectangular shape. Therefore, the radius of curvature of the bent portion 5 varies greatly depending on the lamination position of the steel sheet. Regarding the iron core of the core No. e, in Table 1, * indicates that r increases toward the outside, r=5 mm at the innermost periphery part and r=60 mm at the outermost periphery part. In addition, the iron core of the core No. c is a Unicore type wound core having a larger radius of curvature r (the radius of curvature r exceeds 5 mm) than the iron cores of the cores Nos. a, b, d, and f (Unicore type wound core), and the iron core of the core No. d is a Unicore type wound core having three bent portions 5 at one corner portion 3.

TABLE 1

| | Core shape | | | | | | |
|---|---|---|---|---|---|---|---|
| Core | L1 | L2 | L3 | L4 | L5 | r | ϕ |
| No. | mm | mm | mm | mm | mm | mm | ° |
| a | 197 | 66 | 47 | 152.4 | 4 | 1 | 45 |
| b | 197 | 66 | 47 | 152.4 | 4 | 5 | 45 |
| c | 197 | 66 | 47 | 152.4 | 4 | 6 | 45 |
| d | 197 | 66 | 47 | 152.4 | 4 | 2 | 30 |
| e | 197 | 66 | 47 | 152.4 | 4 | * | 90 |
| f | 197 | 66 | 47 | 152.4 | 4 | 2 | 45 |

Table 2 to Table 5 show, based on various core shapes as described above, the average value (μm) of RSm(b) measured at 10 locations (measured at 10 fields of view) at the bent portion 5 described above, the average value (μm) of RSm(s) measured at 10 locations (measured at 10 fields of view) at the planar portion 4 (4a) described above, the ratio RSm(b)/RSm(s), and the measured bent angle φ′(°), and the building factor (BF) measured and evaluated based on the iron loss (W/kg) of the iron core and the iron loss (W/kg) of the steel sheet obtained by measuring 81 example materials in which the target bent angle φ(°), the steel sheet thickness (mm), and the compressive stress (MPa) applied in the width direction C were set. Here, the above measurement at 10 locations means that, in the case of the bent portion 5, 10 steel sheets were arbitrarily extracted from one wound core, one location of each bent portion was set as one field of view, and RSm(b) and the measured bent angle φ′ were measured. The average lengths RSm(b) and RSm(s) of the roughness curve element both are the average length RSm of the roughness curve element measured using a digital microscope (VHX-7000, commercially available from Keyence Corporation). The average length RSm of the roughness curve element was measured based on JIS B 0601 (2013). The cutoff values were λs=0 and λc=0, and vibration correction was performed for measurement. The measurement magnification was set to 500 to 700.

The building factor was measured by the following method. Regarding the wound cores of the cores No. a to No. f in Table 1, measurement using an excitation current method described in JIS C 2550-1: 2011 was performed under conditions of a frequency of 50 Hz and a magnetic flux density of 1.7 T, and the iron loss value (iron core iron loss) W_{A} of the wound core was measured. In addition, a sample with a width of 100 mm×a length of 500 mm was collected from the hoop (with a sheet width of 152.4 mm) of the grain-oriented electrical steel sheet used for the iron core, the sample was measured according to an electrical steel sheet single magnetic property test using an H coil method described in JIS C 2556: 2015 under conditions of a frequency of 50 Hz and a magnetic flux density of 1.7 T. and the iron loss value (iron loss of the steel sheet) W_{B} of the material single steel sheet was measured. A building factor (BF) was obtained by dividing the obtained iron loss value W_{A} by the iron loss value W_{B}. The results are shown in Table 2 to Table 5. A case with a building factor of 1.06 or less was determined to be satisfactory.

TABLE 2

| | | | | | Average | Average | | | | | |
|---|---|---|---|---|---|---|---|---|---|---|---|
| | | | | | of | of | | | | | |
| | | | | | RSm(b) | RSm(s) | | | | | |
| | | | | | measured | measured | | | | | |
| | | | | | at 10 | at 10 | | | Iron | Iron | |
| | | Target | Steel | | locations | locations | | Measured | loss of | loss of | |
| | | bent | sheet | Compressive | on bent | on planar | Ratio | bent | iron | steel | |
| | Core | angle φ | thickness | stress | portion | portion | RSm(b)/ | angle φ' | core | sheet | |
| No. | No. | (°) | (mm) | (MPa) | (μm) | (μm) | RSm(s) | (°) | (W/kg) | (W/kg) | BF |
| 1 | a | 45 | 0.23 | 0.0 | 0.53 | 0.63 | 0.84 | 43.3 | 0.95 | 0.83 | 1.15 |
| 2 | a | 45 | 0.23 | 0.2 | 0.61 | 0.66 | 0.92 | 43.4 | 0.96 | 0.83 | 1.16 |
| 3 | a | 45 | 0.23 | 0.8 | 0.53 | 0.57 | 0.93 | 43.5 | 0.95 | 0.83 | 1.15 |
| 4 | a | 45 | 0.23 | 1.0 | 0.59 | 0.61 | 0.97 | 43.5 | 0.96 | 0.83 | 1.16 |
| 5 | a | 45 | 0.23 | 2.0 | 0.61 | 0.63 | 0.97 | 43.5 | 0.97 | 0.83 | 1.17 |
| 6 | a | 45 | 0.23 | 3.0 | 0.86 | 0.60 | 1.43 | 43.6 | 0.88 | 0.83 | 1.06 |
| 7 | a | 45 | 0.23 | 3.4 | 0.92 | 0.61 | 1.51 | 43.6 | 0.86 | 0.83 | 1.04 |
| 8 | a | 45 | 0.23 | 3.6 | 1.23 | 0.63 | 1.95 | 44.0 | 0.85 | 0.83 | 1.02 |
| 9 | a | 45 | 0.23 | 4.0 | 1.67 | 0.60 | 2.78 | 44.5 | 0.81 | 0.83 | 0.98 |
| 10 | a | 45 | 0.23 | 4.7 | 2.24 | 0.66 | 3.39 | 45.0 | 0.80 | 0.83 | 0.96 |
| 11 | a | 45 | 0.23 | 7.0 | 2.58 | 0.57 | 4.53 | 44.5 | 0.85 | 0.83 | 1.02 |
| 12 | a | 45 | 0.23 | 13.0 | 2.81 | 0.61 | 4.61 | 44.5 | 0.86 | 0.83 | 1.04 |
| 13 | a | 45 | 0.23 | 16.0 | 2.74 | 0.57 | 4.81 | 45.3 | 0.86 | 0.83 | 1.04 |
| 14 | a | 45 | 0.23 | 17.0 | 3.05 | 0.61 | 5.00 | 45.8 | 0.87 | 0.83 | 1.05 |
| 15 | a | 45 | 0.23 | 18.0 | 4.86 | 0.63 | 7.71 | 47.0 | 0.91 | 0.83 | 1.10 |
| 16 | a | 45 | 0.23 | 25.0 | 5.04 | 0.60 | 8.40 | 47.5 | 0.96 | 0.83 | 1.16 |
| 17 | a | 45 | 0.23 | 30.0 | 6.21 | 0.61 | 10.18 | 48.4 | 1.02 | 0.83 | 1.23 |
| 18 | a | 45 | 0.23 | 0.5 | 0.61 | 0.62 | 0.98 | 43.0 | 0.95 | 0.83 | 1.15 |
| | | | | (tensile stress) | | | | | | | |
| 19 | a | 45 | 0.23 | 4.0 | 0.49 | 0.62 | 0.79 | 42.5 | 0.97 | 0.83 | 1.17 |
| | | | | (tensile stress) | | | | | | | |
| 20 | a | 45 | 0.23 | 10.0 | 0.33 | 0.62 | 0.53 | 41.0 | 1.11 | 0.83 | 1.34 |
| | | | | (tensile stress) | | | | | | | |
| 21 | b | 45 | 0.23 | 0.0 | 0.52 | 0.63 | 0.82 | 43.3 | 0.95 | 0.83 | 1.15 |

TABLE 3

| | | | | | Average | Average | | | | | |
|---|---|---|---|---|---|---|---|---|---|---|---|
| | | | | | of | of | | | | | |
| | | | | | RSm(b) | RSm(s) | | | | | |
| | | | | | measured | measured | | | | | |
| | | | | | at 10 | at 10 | | | Iron | Iron | |
| | | Target | Steel | | locations | locations | | Measured | loss of | loss of | |
| | | bent | sheet | Compressive | on bent | on planar | Ratio | bent | iron | steel | |
| | Core | angle φ | thickness | stress | portion | portion | RSm(b)/ | angle φ' | core | sheet | |
| No. | No. | (°) | (mm) | (MPa) | (μm) | (μm) | RSm(s) | (°) | (W/kg) | (W/kg) | BF |
| 22 | b | 45 | 0.23 | 0.2 | 0.60 | 0.66 | 0.91 | 43.4 | 0.97 | 0.83 | 1.17 |
| 23 | b | 45 | 0.23 | 0.8 | 0.52 | 0.57 | 0.91 | 43.5 | 0.97 | 0.83 | 1.17 |
| 24 | b | 45 | 0.23 | 1.0 | 0.58 | 0.61 | 0.95 | 43.5 | 0.97 | 0.83 | 1.17 |
| 25 | b | 45 | 0.23 | 2.0 | 0.60 | 0.63 | 0.95 | 43.5 | 0.99 | 0.83 | 1.19 |
| 26 | b | 45 | 0.23 | 3.0 | 0.84 | 0.60 | 1.40 | 43.6 | 0.88 | 0.83 | 1.06 |
| 27 | b | 45 | 0.23 | 3.4 | 0.90 | 0.61 | 1.48 | 43.6 | 0.86 | 0.83 | 1.04 |
| 28 | b | 45 | 0.23 | 3.6 | 1.21 | 0.63 | 1.91 | 44.0 | 0.85 | 0.83 | 1.02 |
| 29 | b | 45 | 0.23 | 4.0 | 1.64 | 0.60 | 2.73 | 44.5 | 0.82 | 0.83 | 0.99 |
| 30 | b | 45 | 0.23 | 4.7 | 2.20 | 0.66 | 3.33 | 45.0 | 0.80 | 0.83 | 0.96 |
| 31 | b | 45 | 0.23 | 7.0 | 2.53 | 0.57 | 4.44 | 44.5 | 0.85 | 0.83 | 1.02 |
| 32 | b | 45 | 0.23 | 13.0 | 2.75 | 0.61 | 4.51 | 44.5 | 0.86 | 0.83 | 1.04 |
| 33 | b | 45 | 0.23 | 16.0 | 2.69 | 0.57 | 4.71 | 45.3 | 0.87 | 0.83 | 1.05 |
| 34 | b | 45 | 0.23 | 17.0 | 3.05 | 0.61 | 5.00 | 45.8 | 0.87 | 0.83 | 1.05 |
| 35 | b | 45 | 0.23 | 18.0 | 4.76 | 0.63 | 7.56 | 47.0 | 0.93 | 0.83 | 1.12 |
| 36 | b | 45 | 0.23 | 25.0 | 4.94 | 0.60 | 8.23 | 47.5 | 0.98 | 0.83 | 1.18 |
| 37 | b | 45 | 0.23 | 30.0 | 6.09 | 0.61 | 9.98 | 48.4 | 1.03 | 0.83 | 1.24 |
| 38 | b | 45 | 0.23 | 0.5 | 0.60 | 0.62 | 0.96 | 43.0 | 0.95 | 0.83 | 1.15 |
| | | | | (tensile stress) | | | | | | | |
| 39 | b | 45 | 0.23 | 4 | 0.48 | 0.62 | 0.77 | 42.5 | 0.99 | 0.83 | 1.19 |
| | | | | (tensile stress) | | | | | | | |
| 40 | b | 45 | 0.23 | 10 | 0.32 | 0.62 | 0.52 | 41.0 | 1.13 | 0.83 | 1.36 |
| | | | | (tensile stress) | | | | | | | |

TABLE 4

| | | | | | Average | Average | | | | | |
|---|---|---|---|---|---|---|---|---|---|---|---|
| | | | | | of | of | | | | | |
| | | | | | RSm(b) | RSm(s) | | | | | |
| | | | | | measured | measured | | | | | |
| | | | | | at 10 | at 10 | | | Iron | Iron | |
| | | Target | Steel | | locations | locations | | Measured | loss of | loss of | |
| | | bent | sheet | Compressive | on bent | on planar | Ratio | bent | iron | steel | |
| | Core | angle φ | thickness | stress | portion | portion | RSm(b)/ | angle φ' | core | sheet | |
| No. | No | (°) | (mm) | (MPa) | (μm) | (μm) | RSm(s) | (°) | (W/kg) | (W/kg) | BF |
| 41 | c | 45 | 0.23 | 0.2 | 0.57 | 0.66 | 0.92 | 46.0 | 0.98 | 0.83 | 1.18 |
| 42 | c | 45 | 0.23 | 4.0 | 1.56 | 0.60 | 2.60 | 48.0 | 0.82 | 0.83 | 0.99 |
| 43 | c | 45 | 0.23 | 16.0 | 2.69 | 0.57 | 4.72 | 51.5 | 0.84 | 0.83 | 1.01 |
| 44 | c | 45 | 0.23 | 17.0 | 3.04 | 0.61 | 4.98 | 53.5 | 0.87 | 0.83 | 1.05 |
| 45 | c | 45 | 0.23 | 30.0 | 5.95 | 0.61 | 9.75 | 60.0 | 1.03 | 0.83 | 1.24 |
| 46 | d | 30 | 0.23 | 0.2 | 0.61 | 0.66 | 0.92 | 27.5 | 0.96 | 0.83 | 1.16 |
| 47 | d | 30 | 0.23 | 4.7 | 2.24 | 0.64 | 3.50 | 30.0 | 0.80 | 0.83 | 0.96 |
| 48 | d | 30 | 0.23 | 25.0 | 5.04 | 0.60 | 8.40 | 31.7 | 0.96 | 0.83 | 1.16 |
| 49 | a | 45 | 0.18 | 4.0 | 1.65 | 0.60 | 2.75 | 45.0 | 0.74 | 0.75 | 0.98 |
| 50 | a | 45 | 0.18 | 5.0 | 2.65 | 0.61 | 4.34 | 45.0 | 0.64 | 0.68 | 0.94 |
| 51 | a | 45 | 0.18 | 30.0 | 5.34 | 0.60 | 8.90 | 47.5 | 0.84 | 0.68 | 1.23 |
| 52 | a | 45 | 0.18 | 5 | 0.46 | 0.60 | 0.77 | 40.5 | 0.75 | 0.68 | 1.10 |
| | | | | (tensile stress) | | | | | | | |
| 53 | a | 45 | 0.15 | 0.3 | 0.60 | 0.60 | 1.00 | 41.5 | 0.72 | 0.64 | 1.12 |
| 54 | a | 45 | 0.15 | 4.7 | 2.26 | 0.60 | 3.77 | 45.0 | 0.61 | 0.64 | 0.96 |
| 55 | a | 45 | 0.15 | 20.0 | 4.93 | 0.60 | 8.22 | 48.5 | 0.68 | 0.64 | 1.07 |
| 56 | a | 45 | 0.27 | 4.7 | 2.32 | 0.61 | 3.80 | 45.0 | 0.82 | 0.85 | 0.97 |
| 57 | a | 45 | 0.27 | 15.0 | 2.56 | 0.60 | 4.27 | 44.5 | 0.90 | 0.85 | 1.06 |
| 58 | a | 45 | 0.27 | 20.0 | 5.53 | 0.60 | 9.22 | 49.5 | 0.93 | 0.85 | 1.09 |
| 59 | a | 45 | 0.30 | 0.2 | 0.58 | 0.60 | 0.97 | 41.0 | 0.97 | 0.87 | 1.12 |
| 60 | a | 45 | 0.30 | 4.0 | 2.16 | 0.60 | 3.60 | 43.5 | 0.84 | 0.87 | 0.97 |
| 61 | a | 45 | 0.30 | 16.0 | 2.46 | 0.61 | 4.03 | 47.5 | 0.91 | 0.87 | 1.05 |

TABLE 5

| | | | | | Average | Average | | | | | |
|---|---|---|---|---|---|---|---|---|---|---|---|
| | | | | | of | of | | | | | |
| | | | | | RSm(b) | RSm(s) | | | | | |
| | | | | | measured | measured | | | | | |
| | | | | | at 10 | at 10 | | | Iron | Iron | |
| | | Target | Steel | | locations | locations | | Measured | loss of | loss of | |
| | | bent | sheet | Compressive | on bent | on planar | Ratio | bent | iron | steel | |
| | Core | angle φ | thickness | stress | portion | portion | RSm(b)/ | angle φ' | core | sheet | |
| No. | No. | (°) | (mm) | (MPa) | (μm) | (μm) | RSm(s) | (°) | (W/kg) | (W/kg) | BF |
| 62 | a | 45 | 0.30 | 20 | 0.36 | 0.61 | 0.59 | 37.5 | 1.01 | 0.87 | 1.16 |
| | | | | (tensile stress) | | | | | | | |
| 63 | a | 45 | 0.35 | 5.0 | 2.34 | 0.60 | 3.90 | 44.5 | 0.87 | 0.9 | 0.97 |
| 64 | e | 90 | 0.23 | 2.0 | 0.61 | 0.61 | 0.97 | 88.4 | 1.11 | 0.83 | 1.34 |
| 65 | e | 90 | 0.23 | 4.0 | 1.67 | 0.60 | 2.78 | 88.6 | 1.13 | 0.83 | 1.36 |
| 66 | e | 90 | 0.23 | 17.0 | 3.05 | 0.61 | 5.00 | 88.4 | 1.15 | 0.83 | 1.39 |
| 67 | e | 90 | 0.23 | 30.0 | 6.21 | 0.61 | 10.18 | 88.4 | 1.13 | 0.83 | 1.36 |
| 68 | d | 30 | 0.23 | 3.0 | 0.62 | 0.60 | 1.03 | 27.6 | 0.86 | 0.83 | 1.04 |
| 69 | d | 30 | 0.23 | 17.0 | 3.05 | 0.61 | 5.00 | 30.7 | 0.86 | 0.83 | 1.04 |
| 70 | a | 45 | 0.35 | 15.0 | 2.76 | 0.61 | 4.52 | 47.5 | 0.93 | 0.9 | 1.03 |
| 70 | a | 45 | 0.35 | 25.0 | 4.75 | 0.61 | 7.79 | 53.4 | 0.97 | 0.9 | 1.08 |
| 71 | c | 45 | 0.18 | 5.0 | 2.23 | 0.62 | 3.60 | 43.5 | 0.70 | 0.68 | 1.03 |
| 72 | c | 45 | 0.20 | 20.0 | 6.65 | 0.61 | 10.90 | 48.5 | 0.83 | 0.7 | 1.18 |
| 73 | c | 45 | 0.23 | 2.1 | 0.60 | 0.61 | 0.98 | 42.7 | 0.95 | 0.83 | 1.14 |
| 74 | c | 45 | 0.23 | 7.0 | 1.75 | 0.61 | 2.87 | 46.4 | 0.71 | 0.68 | 1.04 |
| 75 | c | 45 | 0.23 | 11.0 | 2.44 | 0.61 | 4.00 | 47.8 | 0.73 | 0.7 | 1.04 |
| 76 | c | 45 | 0.23 | 18.0 | 3.14 | 0.61 | 5.15 | 49.0 | 1.05 | 0.83 | 1.27 |
| 77 | c | 45 | 0.23 | 34.0 | 8.27 | 0.61 | 13.56 | 53.0 | 1.01 | 0.83 | 1.22 |
| 78 | f | 45 | 0.18 | 7.0 | 2.05 | 0.61 | 3.36 | 43.2 | 0.66 | 0.68 | 0.97 |
| 79 | f | 45 | 0.20 | 11.0 | 1.79 | 0.61 | 2.93 | 44.0 | 0.71 | 0.7 | 1.01 |
| 80 | f | 45 | 0.23 | 20.0 | 3.13 | 0.61 | 5.13 | 47.0 | 1.04 | 0.83 | 1.25 |
| 81 | f | 45 | 0.23 | 47.0 | 6.26 | 0.62 | 10.10 | 56.0 | 0.98 | 0.83 | 1.18 |

As can be understood from Table 2 to Table 5, regarding the iron cores of the cores Nos. a, b, c, d, and f forming a Unicore type, if the steel sheet thickness was within a range of 0.15 mm to 0.35 mm, regardless of the sheet thickness, a compressive stress within a range of 3 MPa or more and 17 MPa or less was applied in the width direction C, and thus the ratio RSm(b)/RSm(s) satisfying the relationship of 1.00<RSm(b)/RSm(s)≤5.00 was obtained, and accordingly, the building factor (BF) was reduced to 1.06 or less (the iron loss of the wound core was minimized). In addition, noise properties were improved with respect to these. On the other hand, Nos. a, b, d, and f having a small radius of curvature (5 mm or less) of the bent portion had a BF that was reduced to be lower than that of the iron core of the core No. c forming a Unicore type and having a radius of curvature of 6 mm of the bent portion. In the case of the iron core of the core No. e forming a trunk core type, even if the relationship of 1.00<RSm(b)/RSm(s)≤5.00 was satisfied by applying a compressive stress within a range of 3 MPa or more and 17 MPa or less in the width direction C, the building factor (BF) could not be sufficiently minimized.

Based on the above results, it can be clearly understood that, in the wound core of the present invention, since the relationship of 1.00<RSm(b)/RSm(s)≤5.00 was satisfied when bending was performed while compressive stress was applied to the entire end surface (L cross section) of the steel sheet to be bent in the width direction, due to minimization of bending return after bending, the elastic stress acting in the iron core was reduced when the steel sheets were stacked and assembled, and deterioration of the iron loss was reduced.

### BRIEF DESCRIPTION OF THE REFERENCE SYMBOLS

1 Grain-oriented electrical steel sheet
4, 4a Planar portion
5 Bent portion
10 Wound core (wound core main body)
50 Device
70 Production device
71 Bending unit
72 Assembly unit

1. A wound core including a portion in which grain-oriented electrical steel sheets in which planar portions and bent portions are alternately continuous in a longitudinal direction are stacked in a sheet thickness direction and formed by stacking the grain-oriented electrical steel sheets that have been individually bent in layers and assembled into a wound shape,
wherein, when an average length of a roughness curve element in a width direction intersecting the longitudinal direction forming a surface of the bent portion of the grain-oriented electrical steel sheet is RSm(b), and an average length of the roughness curve element in the width direction forming a surface of the planar portion of the grain-oriented electrical steel sheet is RSm(s), the relationship of 1.00<RSm(b)/RSm(s)≤5.00 is satisfied.

2. The wound core according to claim 1,
wherein the bent portion has a radius of curvature of 1 mm or more and 5 mm or less.

3. A method of producing a wound core, comprising:
a bending process in which grain-oriented electrical steel sheets are individually bent; and
an assembling process in which the bent grain-oriented electrical steel sheets are stacked in layers and assembled into a wound shape to form a wound core having a wound shape including a portion in which grain-oriented electrical steel sheets in which planar portions and bent portions are alternately continuous in a longitudinal direction are stacked in a sheet thickness direction,
wherein, in the bending process, the grain-oriented electrical steel sheet is bent while a compressive stress in a range of 3 MPa or more and 17 MPa or less is applied to the grain-oriented electrical steel sheet in a width direction.

4. The method of producing a wound core according to claim 3,
wherein, in the bending process, the grain-oriented electrical steel sheet is bent so that the radius of curvature of the bent portion of the grain-oriented electrical steel sheet is 1 mm or more and 5 mm or less.

5. A wound core production device, comprising:
a bending unit that individually bends grain-oriented electrical steel sheets; and
an assembly unit that stacks the bent grain-oriented electrical steel sheets in layers and assembles them into a wound shape to form a wound core having a wound shape including a portion in which grain-oriented electrical steel sheets in which planar portions and bent portions are alternately continuous in a longitudinal direction are stacked in a sheet thickness direction,
wherein the bending unit bends the grain-oriented electrical steel sheet while applying a compressive stress in a range of 3 MPa or more and 17 MPa or less to the grain-oriented electrical steel sheet in a width direction.

6. The wound core production device according to claim 5,
wherein the bending unit bends the grain-oriented electrical steel sheet so that the radius of curvature of the bent portion of the grain-oriented electrical steel sheet is 1 mm or more and 5 mm or less.
